(19) United States
(12) Patent Application Publication
(10) Pub. No.: US 2025/0169604 A1
(43) Pub. Date: May 29, 2025

(54) MULTI-CUBE ROOM ORGANIZER

(71) Applicant: Davalon, LLC, Rolling Meadows, IL (US)

(72) Inventor: Gregory Mohr, Rolling Meadows, IL (US)

(73) Assignee: Davalon, LLC, Rolling Meadows, IL (US)

(21) Appl. No.: 18/523,570

(22) Filed: Nov. 29, 2023

(51) Int. Cl. A47B 47/00; F16B 12/14; F16B 12/24

(52) U.S. Cl. CPC A47B 47/0075; F16B 12/14; F16B 12/24; A47B 2230/0037; A47B 2230/07; A47B 2230/11

(57) ABSTRACT

A multi-cube room organizer which may be easily and rapidly assembled using different panels and different fastener types.

### BACKGROUND OF THE INVENTION

The present invention generally relates to a multi-cube room organizer.

There is a need for durable shelving that functions as a room organizer and that is easy to install and use.

Accordingly, the multi-cube room organizer of the present invention provides this need.

### SUMMARY OF THE INVENTION

The objects mentioned above, as well as other objects, are solved by the present invention, which overcomes disadvantages of prior room organizers, while providing new advantages not previously associated with such room organizers. This summary is provided to introduce a selection of concepts in a simplified form that are further described below in the Detailed Description, so that the claimed invention may be better understood. However, this summary is not intended to limit the scope of the claimed subject matter.

In one preferred embodiment of the invention, an 8-cube room organizer is provided having: (a) a first shelving unit including a first plurality of panels forming a 4-cube room organizer with four individual cubes, the panels being attached to each other using a first type of fasteners; (b) a second shelving unit including second plurality panels forming a 4-cube room organizer with four individual cubes, the panels being attached to each other using the first type of fasteners; and (c) the first and second shelving units are attached to each other using a plurality of a second type of fasteners, the second type of fasteners each requiring tightening at only one end, and wherein at least a portion of the second type of fastener is housed within panels bearing cutouts which provide room for a tightening tool used to tighten the only one end of the second type of fastener.

The first type of fastener may consist of various fasteners such as screws, bolts, or wooden dowels, for example. The second type of fastener may consist of draw bolts, for example. The draw bolts may be tightened to a fastener (e.g., a nut) embedded in panels adjacent to the panels bearing the cutouts.

The first and second shelving units may be attached to form an 8-cube room organizer, by first removing a horizontal panel from one of the first or the second shelving units.

In another embodiment of the present invention, a method is provided for creating an 8-cube room organizer, including the steps of: (a) forming a first shelving unit by attaching a plurality of panels using a first type of fasteners, to form a 4-cube room organizer with four individual cubes; (b) forming a second shelving unit by attaching a plurality of panels using the first type of fasteners, to form a second 4-cube room organizer with four individual cubes; (c) attaching the first and second units to each other to form an 8-cube room organizer using a plurality of a second type of fasteners, wherein each of the second type of fasteners requires tightening at only one end, and wherein at least a portion of the second type of fasteners is each housed within panels bearing cutouts, the cutouts providing room for a tightening tool used to tighten the only one end of the second type of fastener.

Prior to the step of attached the first and second units to each other, a horizontal panel may be removed from one of the first or the second shelving units. The first type of fastener may include, e.g., a wooden dowel, and the second type of fastener may include, e.g., a draw bolt.

In yet another embodiment of the present invention, an 8-cube room organizer is provided, and includes a shelving unit having two opposing vertical exterior panels connected to: (a) five horizontal panels, which include three interior horizontal panels and two exterior horizontal panels, and (b) four interior vertical panels. At least two different fastener types are used for attachment, including: a first type of fastener is used to connect the three interior horizontal panels to the two opposing vertical exterior side panels, and to connect the four interior vertical panels to the five horizontal panels; and (ii) a second type of fastener is used to connect the two exterior horizontal panels to the two opposing vertical panels. The 8 first type of fastener may include, e.g., wooden dowels, and the second type of fastener may be of a type that requires tightening at only one end. At least a portion of the second type of fasteners may be each housed within a cutout located within at least one of the two opposing vertical panels. The cutout provides room for a tightening tool used to tighten the only one end of the second type of fastener. One example of the second type of fastener is a draw bolt and nut.

In another embodiment, a third type of fastener, such as a cam lock assembly, may also be used for attaching any of the panels, such as for connecting opposing ends of an interior middle horizontal shelf to each of the two opposing vertical panels.

### DEFINITION OF CLAIM TERMS

The terms used in the claims of the patent are intended to have their broadest meaning consistent with the requirements of law. Where alternative meanings are possible, the broadest meaning is intended. All words used in the claims are intended to be used in the normal, customary usage of grammar and the English language.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a planar perspective view of a 4-cube room organizer according to one embodiment of the present invention;

FIGS. 2 and 3 are partial, enlarged planar perspective views of top and bottom portions, respectively, of a vertical panel of the room organizer according to an embodiment of the present invention shown in FIG. 1;

FIG. 4 is a view similar to FIG. 1, with the bottom horizontal shelf disassembled;

FIG. 5 is an exploded perspective parts view of FIG. 1;

FIG. 6 is a partial, enlarged planar perspective view of the intersection of side and horizontal panels from FIG. 9, showing the use of a draw bolt to connect adjacent 4-cube room organizers;

FIG. 7 is an enlarged view of one embodiment of the draw bolt;

FIG. 8 is a partial, enlarged planar perspective view of the bottom of a side panel adjacent the end of horizontal panel to which it will be connected, for use in creating an 8-cube room organizer;

FIG. 9 is a planar perspective view of the nearly-assembled 8-cube room organizer;

FIG. 10 is a planar perspective view of the assembled 8-cube room organizer;

FIG. 11 is a planar perspective view of a different embodiment of an 8-cube room organizer during the assembly process, with the left-side vertical panel being assembled;

FIG. 12 is a partial, enlarged planar perspective view of an interior horizontal shelf being assembled to a side panel for use in an 8-cube room organizer, using a cam lock assembly; and

FIG. 13 is an enlarged perspective view of a cam lock assembly useful with the present invention.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

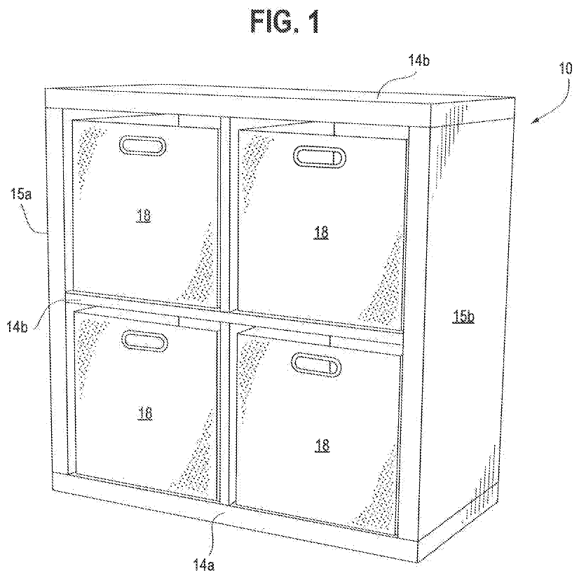

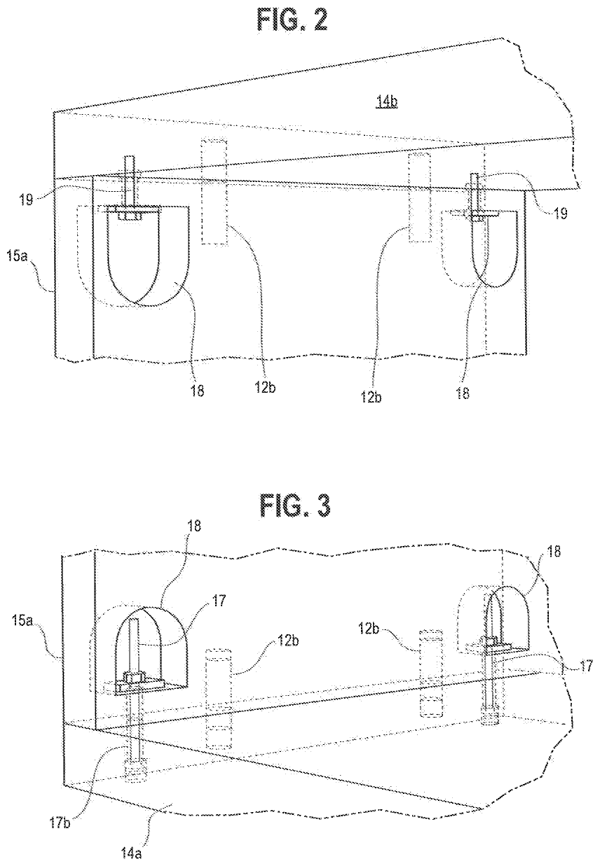

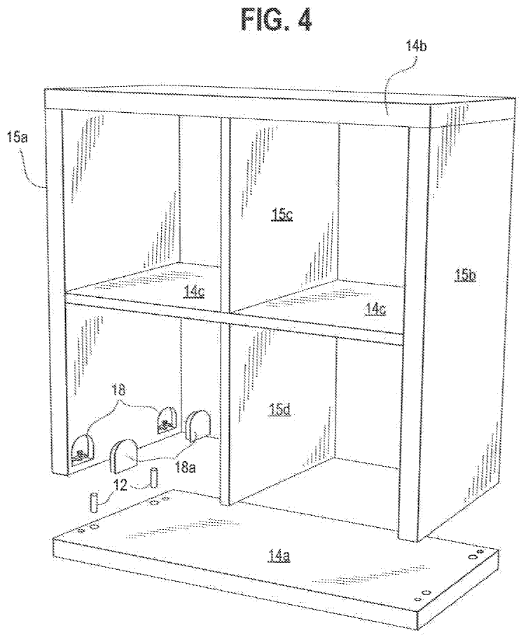

Referring first to FIG. 1, the present invention generally concerns a room organizer consisting of two or more 4-cube units 10, one of which is shown in FIG. 1. Each 4-cube unit 10 may include individual drawers 18 (which may consist of cloth covering a wire frame, for example) slidable within each of the four cubicles forming part of unit 10. With this embodiment, and referring now also to FIGS. 2-5, wooden dowels 12 may be inserted into the apertures 12b shown in dotted lines. In this manner, interior vertical panels 15c, 15d may be attached to horizontal panels 14a, 14b and 14c, as shown; also, side panels 15a, 15b may be attached to the horizontal panels.

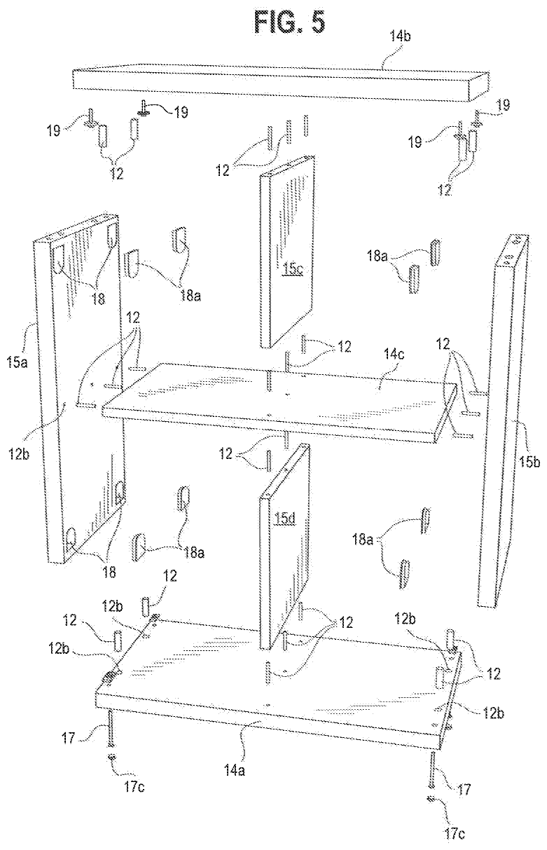

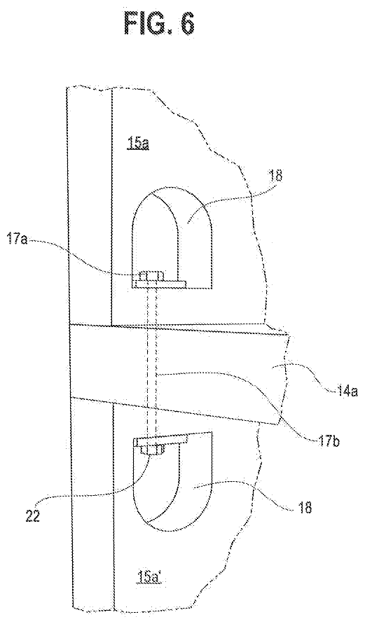

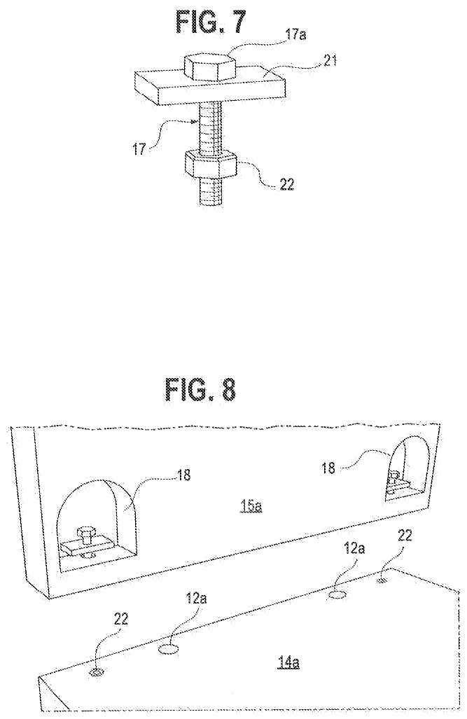

Still referring to FIGS. 1-5, a secure and quick attachment of vertical panels 15a, 15b to top and bottom horizontal panels 14b, 14a will now be described. Referring first especially to FIG. 5, top horizontal panel 14b may include embedded nuts (not shown) so that screws 19 do not go all the way through the panel, presenting a clean appearance. Referring now to FIGS. 2, 3, 5 and 6, bottom horizontal panel 14a may be attached to vertical side panels 15a, 15b using draw bolts 17. Draw bolt 17 is inserted into aperture 17b within a side panel. Because nuts 22 may be embedded in the top and bottom horizontal panels (e.g., FIG. 8), draw bolts 17 may quickly be tightened into these nuts 22 only by rotating head 17a (FIG. 7) using a tightening tool. Aperture 17b preferably runs all the way through the panel, permitting attachment to an additional unit to create an 8-cube room organizer, as discussed below. Horseshoe-shaped cutouts 18 may be used as shown, providing room for use of a tightening tool, but also providing a clean appearance as these cutouts are preferably covered using caps 18a (FIG. 5). Caps 17c (FIG. 5) may also be used to cover the ends of draw bolts 17. A clean appearance on both top and bottom panels 14b and 14a′ is achieved with these attachment mechanisms, including the draw nut connections, which avoid exposed screw holes on the exterior of the units.

It will be understood and appreciated by those of ordinary skill in the art that horseshoe-shaped cutouts 18 enable easy and rapid connection by providing adequate room to employ tightening tools, without taking up too much space. It will also be appreciated that using draw bolts 17, tightening is only required on one end, as the opposite end is fixed by connection to sunken nut 22, speeding assembly. Nut 21 on draw bolt 17 provides extra friction to facilitate tightening of the draw bolts.

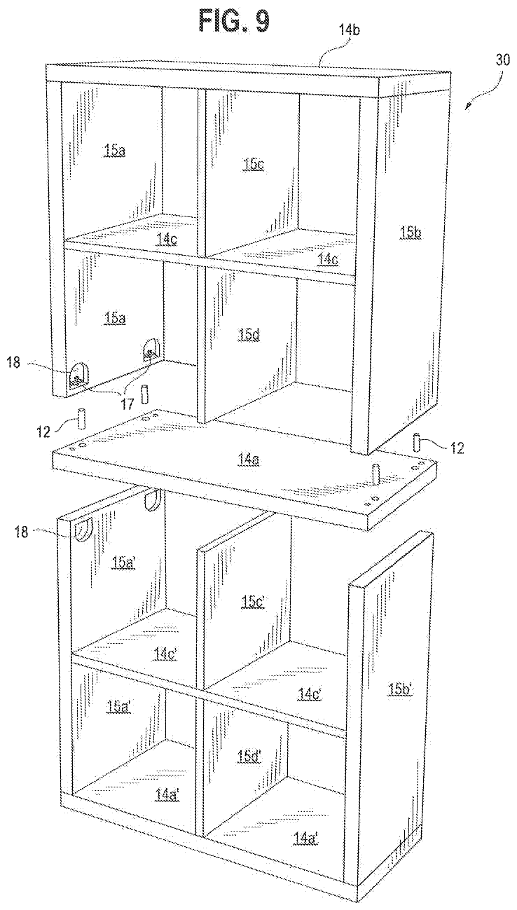

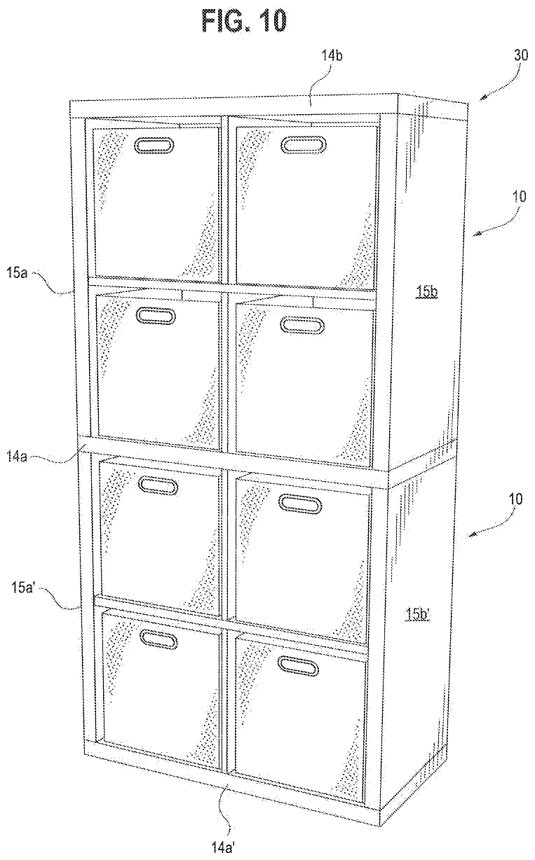

Referring now to FIGS. 9-10, an 8-cube room organizer unit 30 may be created. In one example, in order to create unit 30, one of the horizontal panels from two 4-cube organizers 10 may be removed, and inverted, and then the two units 10 may be attached as shown (FIG. 9), using wooden dowels 12 and draw bolts 17, as discussed above.

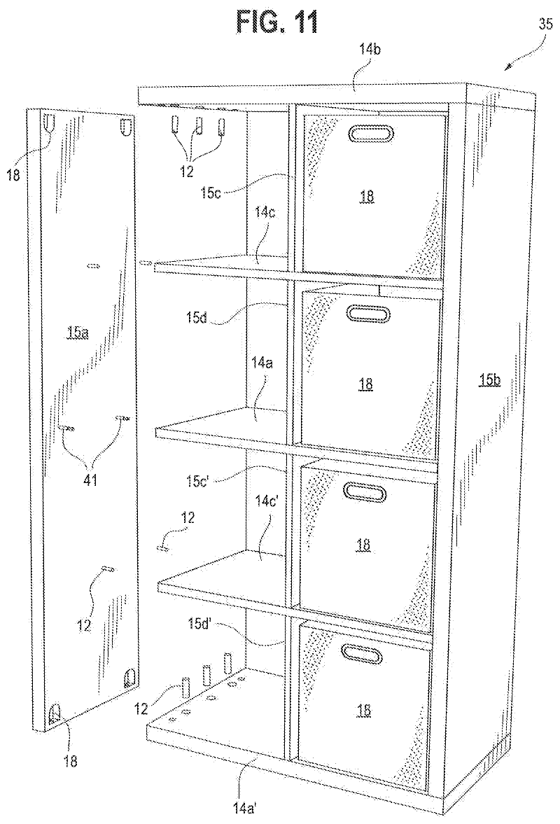

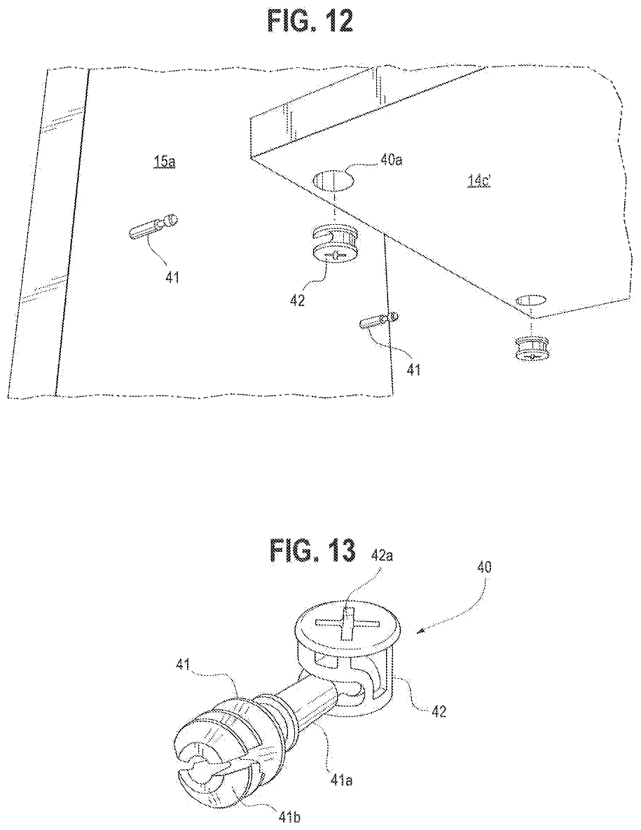

Referring now to FIGS. 11-13, an alternative embodiment is shown for creating an 8-cube room organizer 35. With this embodiment, single vertical side panels 15a, 15b may be used. Also, fasteners may be employed as discussed above. Alternatively, a cam lock assembly 30 may be used to secure the horizontal panels to the horizontal panels, as shown. Referring to FIG. 13, cam lock assembly 40 includes a male groove adaptor 41 with a screw end 41b and a pin end 41a which fits into the side of a female coupler 42 having a groove 42a to accommodate a tightening tool. Female coupler 42 may be slid into an aperture 40a of a panel, as shown in FIG. 12. As is well known, rotation of female coupler 42 using a tightening tool causes horizontal panel (e.g., 14c′) to be tightened against vertical panel (e.g., 15a).

The above description is not intended to limit the meaning of the words used in the following claims that define the invention. Persons of ordinary skill in the art will understand that a variety of other designs still falling within the scope of the following claims may be envisioned and used. For example, while the 8-cube units are shown stacked vertically, they can of course be used in a horizontal layout. It is contemplated that these additional examples, as well as future modifications in structure, function, or result to that disclosed here, will exist that are not substantial changes to what is claimed here, and that all such insubstantial changes in what is claimed are intended to be covered by the claims.

We claim:

1. An 8-cube room organizer, comprising:
a first shelving unit comprising a first plurality of panels forming a 4-cube room organizer with four individual cubes, wherein the first plurality of panels are attached to each other using a first type of fasteners;
a second shelving unit comprising a second plurality panels forming a 4-cube room organizer with four individual cubes, wherein the second plurality of panels are attached to each other using the first type of fasteners;
wherein the first and second shelving units are attached to each other using a plurality of a second type of fasteners, the second type of fasteners each requiring tightening at only one end, and wherein at least a portion of the second type of fastener is housed within panels bearing cutouts which provide room for a tightening tool used to tighten the only one end of the second type of fastener.

2. The 8-cube room organizer of claim 1, wherein the second type of fasteners comprises draw bolts.

3. The 8-cube room organizer of claim 3, wherein the draw bolts are tightened to a fastener embedded in panels adjacent to the panels bearing the cutouts.

4. The 8-cube room organizer of claim 1, wherein when the first and second shelving units are attached to form an 8-cube room organizer, a horizontal panel is first removed from one of the first or the second shelving units.

5. The 8-cube room organizer of claim 1, wherein the first type of fasteners comprises wooden dowels.

6. A method for creating an 8-cube room organizer, comprising the steps of;
forming a first shelving unit by attaching a plurality of panels using a first type of fasteners, to form a 4-cube room organizer with four individual cubes;
forming a second shelving unit by attaching a plurality of panels using the first type of fasteners, to form a 4-cube room organizer with four individual cubes;
attaching the first and second units to each other to form an 8-cube room organizer using a plurality of a second type of fasteners, wherein each of the second type of fasteners requires tightening at only one end, and wherein at least a portion of the second type of fasteners is each housed within panels bearing cutouts, the cutouts providing room for a tightening tool used to tighten the only one end of the second type of fastener.

7. The method of claim 6, further comprising the step of removing a horizontal panel from one of the first or the second shelving units, prior to the attachment of the first and the second shelving units to each other to form an 8-cube room organizer.

8. The method of claim 6, wherein the first type of fastener comprises a wooden dowel, and the second type of fastener comprises a draw bolt.

9. An 8-cube room organizer, comprising:
a shelving unit comprising two opposing vertical exterior panels connected to: (a) five horizontal panels, which include three interior horizontal panels and two exterior horizontal panels, and (b) four interior vertical panels;
wherein at least two different fastener types are used for the connections, including:
(i) a first type of fastener is used to connect the three interior horizontal panels to the two opposing vertical exterior side panels, and to connect the four interior vertical panels to the five horizontal panels; and
(ii) a second type of fastener is used to connect the two exterior horizontal panels to the two opposing vertical panels.

10. The 8-cube room organizer of claim 9, wherein the first type of fastener comprises wooden dowels.

11. The 8-cube room organizer of claim 9, wherein the second type of fastener requires tightening at only one end.

12. The 8-cube room organizer of claim 11, wherein at least a portion of the second type of fasteners is each housed within a cutout located within at least one of the two opposing vertical panels, the cutout which provides room for a tightening tool used to tighten the only one end of the second type of fastener.

13. The 8-cube room organizer of claim 12, wherein the second type of fastener comprises a draw bolt and nut.

14. The 8-cube room organizer of claim 9, further comprising a third type of fastener for connecting opposing ends of an interior middle horizontal shelf to each of the two opposing vertical panels.

15. The 8-cube room organizer of claim 14, wherein the third type of fastener comprises a cam lock assembly.
